(19) United States
(12) Patent Application Publication
(10) Pub. No.: US 2012/0019654 A1
(43) Pub. Date: Jan. 26, 2012

(54) MEASUREMENT OF VIBRATION CHARACTERISTICS OF AN OBJECT

(76) Inventors: Varun Akur Venkatesan, Bangalore (IN); Venkatesh Bagaria, Bangalore (IN); Garimella Padma Madhuri, Bangalore (IN)

(21) Appl. No.: 13/146,969

(22) PCT Filed: Nov. 24, 2009
(86) PCT No.: PCT/EP09/65715

§ 371 Date: Oct. 10, 2011

(30) Foreign Application Priority Data
Jan. 30, 2009 (IN) 171/KOL/2009

(51) Int. Cl. H04N 7/18

(52) U.S. Cl. 348/142; 348/E07.085

(57) ABSTRACT

A method and apparatus for measuring the vibration characteristics of an object is disclosed. The method includes illuminating the object using at least two light sources, the at least two light sources emitting light of distinct colors wherein each of the at least two light sources are strobed at a respective delay, capturing reflected light from the object to result into one image of the object, the image including at least two distinguishable color channels capable of distinguishing the distinct colors of the light, and processing the image to compute the vibration characteristics associated with the object from positions of the points on the object in the at least two distinguishable color channels of the image.

### CROSS REFERENCE TO RELATED APPLICATIONS

This application is the US National Stage of International Application No. PCT/EP2009/065715, filed Nov. 24, 2009 and claims the benefit thereof. The International Application claims the benefits of Indian application No. 171/KOL/2009 IN filed Jan. 30, 2009. All of the applications are incorporated by reference herein in their entirety.

### FIELD OF INVENTION

The present invention relates to a method and apparatus for measuring vibration characteristics of moving objects.

### BACKGROUND OF INVENTION

Characterization of vibration motion is essential for the study of many physical and dynamic systems. Vibration frequency measurement is critical for estimating the life and health of complex structures or machine parts and also for performance analysis. Conventionally, strain gage, camera, and laser Doppler based methods have been employed for measuring vibrations. However, these methods exhibit potential drawbacks.

Strain gages are applied on the vibrating object with wires leading out of it. The strain gage measures change in resistance, as the strain in each of the points where the gages the placed, and hence only small displacement can be measured. The systems are primitive and necessitate extensive wiring as the number of points of measurement increases and are also not possible for use in rotating parts. Further, the systems need to be stuck on to the object which introduces errors due to mass loading and also makes it cumbersome due to the presence of wires. The systems are also limited by a minimum and maximum displacement to be measured. Moreover, they are not reusable.

Camera based systems capture displacement of various points on a surface over time and studies the vibration. However, these systems are limited by frame rates. The cost of cameras increases as the frame rates increases, thereby inducing a limit on the frame rate. Hence higher speeds cannot be captured as they have a maximum and minimum limitation of speed for a vibrating object to measure the vibrating frequency.

Conventionally, the laser vibrometers can measure vibrations at one point only. The systems use prohibitively expensive techniques and apparatuses to measure vibration at different directions. Further, they cannot measure spatial modes of vibration, which are required for damage and impact analysis.

### SUMMARY OF INVENTION

It is an objective of the invention to eliminate or at least minimize the above mentioned problems.

The above objective is achieved by a method of measuring vibration characteristics associated to an object, wherein the method comprises illuminating an object using at least two light sources, the at least two light sources emitting light of distinct colors, wherein each of the at least two light sources are strobed at a respective delay, capturing reflected light from the object to result into one image of the object, the image comprising at least two distinguishable color channels capable of distinguishing the distinct colors of the light, and processing the image to compute the vibration characteristics associated with motion of the object from positions of points on the object in at least two distinguishable color channels of the image.

Thereby, enabling measurement of characteristics associated with vibration motion of the objects using low cost cameras.

According to an embodiment, each of the at least two light sources are strobed for a pre-determined on-time at the respective delay, wherein the respective delay is predetermined.

This enables capturing of plurality of points of the vibrating object at varying time instances in one image.

According to yet another embodiment, at least two light sources are selected from the group consisting of a red light source, a green light source, and a blue light source.

This enables capturing the reflected light from the object to result into an image as the object may comprise at least one of the principle colours.

According to yet another embodiment, the characteristic associated with motion of the object is one of the group consisting of displacement and frequency.

According to yet another embodiment, the displacement is computed as the distance between positions of the points on the object in two color channels of the at least two distinguishable colour channels of the image.

According to yet another embodiment, the displacement at points on the object is located using at least one of feature points or reflective markers.

According to yet another embodiment, the displacement is computed using a pattern matching algorithm.

Thereby, providing greater accuracy in environments where displacement associated with vibrations of a plurality of points on the object are measured.

According to yet another embodiment, the computation of the displacement using the pattern matching algorithm includes obtaining position information of the points on the object in two colour channels of the at least two colour channels of the image, reducing the object in the two color channels of the at least two colour channels of the image to a point to obtain point sets, mapping the corresponding points of the object in the point sets of the two color channels of the at least two colour channels of the image, and computing the displacement of the object as a distance between corresponding points of the object in the point sets of the two colour channels of the at least two color channels of the image.

According to yet another embodiment, the frequency of vibration of the object is computed using a time wrapping algorithm.

According to yet another embodiment, computation of the frequency using the wrapping algorithm includes, initializing a time period for obtaining position information of point on the vibrating object in the at least two distinguishable color channels of the image, wrapping the position information of the points on the object in the two color channels of the at least two color channels of the image into the time period, mapping the corresponding the points of the object in the point sets of the two color channels of the at least two color channels of the image at the time period, and computing time period of a dominant cycle by equating wrap time period of the points with the initialized time period.

Thereby, obtaining a clustered image of the object, indicating the dominant cycle, when the wrapping time of points is same as that of the time period.

According to yet another embodiment, wherein if the wrap time period of points is different of the time period, a time period corresponding to least value of error metric of the points in the point sets of the object in the at least two color channels of the image is computed.

According to yet another embodiment, the error metric represents root mean square value of the distance between distinct consecutive points in the point set of the object.

Thereby, obtaining the dominant cycle of vibration of the point on the object to determine the vibration frequency of the object.

Another embodiment includes an apparatus for measuring vibration characteristics associated to an object, wherein the apparatus comprises an illuminating device comprising at least two light sources, the at least two light sources emitting light of distinct colors, wherein each of the at least two light sources are strobed at a respective delay, a color camera to capture reflected light from the object to result into one image of the object, the image comprising at least two distinguishable color channels capable of distinguishing the distinct colors of the light, and a processor to process the image to the vibration characteristics associated with the object from positions of the object in the at least two distinguishable color channels of the image.

Thereby, eliminating the need of expensive high speed cameras for measuring characteristics associated with vibration of an object.

### BRIEF DESCRIPTION OF THE DRAWINGS

The present invention is further described hereinafter with reference to illustrated embodiments shown in the accompanying drawings, in which:

FIG. 1 illustrates a block diagram depicting an apparatus for measuring vibration characteristics associated with motion of an object according to an embodiment herein,

FIG. 2 illustrates a schematic diagram depicting strobing of light sources for acquiring high speed images an object according to an embodiment herein,

FIG. 3 illustrates an exemplary depiction of a sample collection phase of images according to an embodiment herein,

FIG. 4A illustrates an exemplary depiction of clustered image samples at correct wrapping time according to an embodiment herein,

FIG. 4B illustrates an exemplary depiction of scattered image samples at incorrect wrapping time according to an embodiment herein,

FIG. 5 illustrates a flow diagram illustrating a method of computing displacement of a vibrating object according to an embodiment herein, and

FIG. 6 illustrates a flow diagram illustrating a method of measuring frequency of vibration of an object using a time wrapping algorithm according to an embodiment herein.

Various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

### DETAILED DESCRIPTION OF INVENTION

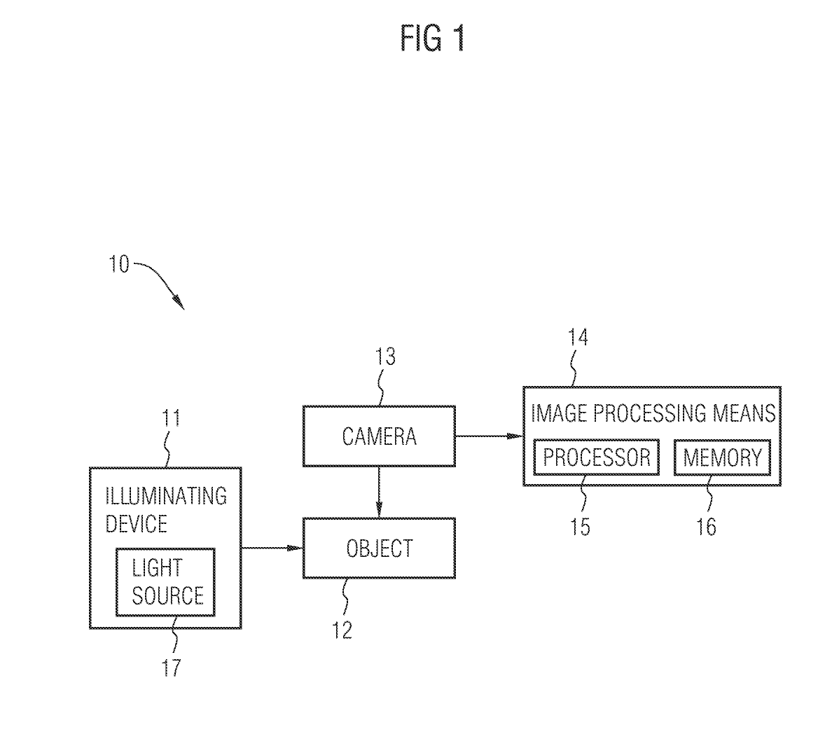

FIG. 1 illustrates a block diagram depicting an apparatus for measuring a vibration characteristics associated with motion of an object 12 in accordance with an embodiment of the invention. The apparatus 10 comprises of an illuminating device 11 to illuminate the object 12, a camera 13 to capture the image of the vibrating objects 12, and an image processing means 14 to compute a vibration characteristics of the objects 12. The vibration characteristics of objects 12 measured herein includes displacement and frequency.

In the shown example of FIG. 1, the illuminating device 11 comprises at least two light sources 17, wherein the light sources emit light of distinct colors. The light sources 17 are selected from the principle colors red, green and blue. Each of the light sources 17 is strobed at a respective predetermined delay for a respective predetermined ON time. The object 12 shall reflect the light projected on it by the light sources 17 for the respective predetermined on-time. For example, the object 12 illuminated using an illuminating device 11 comprising three light sources 17, such as, a red light source, a green light source and a blue light source will reflect red color light, green color light and blue color light respectively.

The camera 13 is exposed for the entire duration of strobing of the light sources 17, and thus, captures the reflected light of distinct colors from the object 12 into one image comprising distinguishable color channels. The image obtained is a composite image comprising the plurality of color channels. For an example, the number of color channels in an image is equivalent to the number of light sources illuminating the object 12. Therefore, the composite image comprises the colour channels that are capable of distinguishing the distinct colors of the light produced by the light sources, for example, the red, green, and blue colors. Thus, illuminating the object 12 with light sources 17 emitting light of distinct colors and exposing the camera for the entire duration of strobing of the light sources 17 enable capturing the distinct colors of light reflected by the object 12 at varying instances of time into one image. Capturing the reflected light of distinct colors from the object 12 at varying instances of time in one image allows imaging of a vibrating object 12. The capturing of the reflected light from the object 12 in color channels capable of distinguishing the distinct colors of light enable determining the position of the object 12 at varying instances of time.

In an embodiment, the image processing means 14 comprises a processor 15 operationally coupled to a memory 16. The processor 15 processes the image captured by the camera 13 to compute the vibration characteristics of the object 12 by determining the positions of the feature points 18 of the object 12 in the different color channels of the image. The memory 16 may comprise stored there in algorithms to determine the displacement and frequency of vibration of the object 12. The displacements at various points 18 on the vibrating object 12 are captured by the location of the feature points. The pattern matching algorithm enables to match various points 18 on the object 12 in different color channels of the image. The distance between the points 18 of the object 12 in two color channels of the image provides the displacement of the object 12.

The image at different positions of the object 12 in different color channels are captured and are then analyzed to obtain the feature points. After a sufficient number of images are obtained, an algorithm fed to the memory 16 is used to calculate the frequency of each point 18 in the point set on the vibrating object 12.

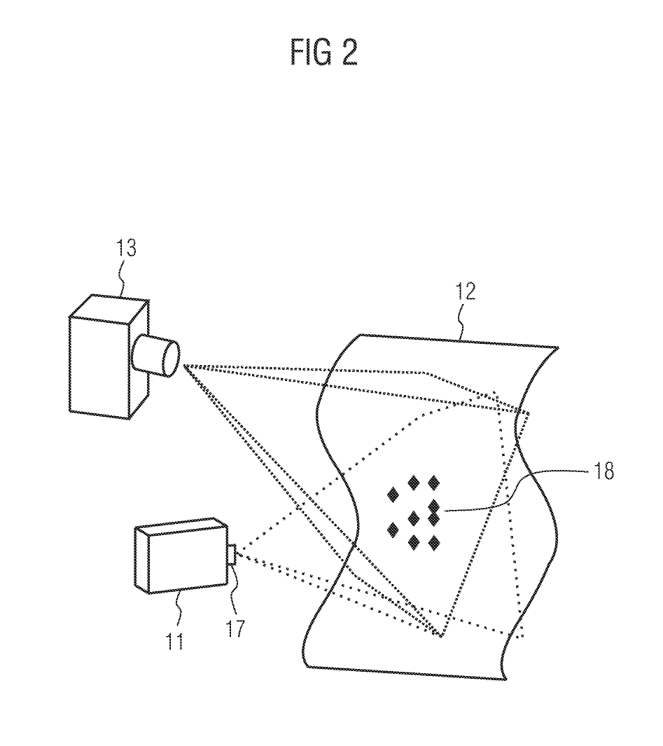

FIG. 2 illustrates a schematic diagram depicting strobing of light sources for acquiring high speed images an object according to an embodiment herein. In the example of FIG. 2, the illuminating device 11 comprises three light sources 17. The apparatus 10 acquires high speed images of the object 12 using the illuminating device 11 and captures the images using a camera 13 in the same exposure time. The illuminating device 11 can be, for instance, RGB strobe light source 17. Each of the light sources 17 is strobed after a time delay from a reference period for an on-time. The camera 13 is exposed for a time, such that the reflected light form the object 12 due to the illumination of the object 12 using the light sources 17 is captured in a single image frame. Hence, a low cost camera 13 can now obtain three image frames at small intervals of time apart. An inter-frame delay corresponding to the image acquisition time occurs followed by consecutive image acquisition.

Thus, illuminating the object 12 with light sources 17 emitting light of distinct colors and exposing the camera 13 for the entire duration of strobing of the light sources 17 enable capturing the distinct colors of light reflected by the object 12 at varying instances of time into one image. Capturing the reflected light of distinct colors from the object 12 at varying instances of time in one image allows imaging of the vibrating object 12. The capturing of the reflected light from the object 12 in color channels capable of distinguishing the distinct colors of light enable deter mining the position of the object 12 at varying instances of time. The displacements at various points on the vibrating object 12 are captured by examining the location of feature points of the object 12 in at least two color channels of the image.

For an example, the first light source may be a red light source, the second light source may be a green light source and the third light source may be a blue light source. The on-time of camera 13 and the time delays may be adjusted depending on the area of application. For example, for obtaining frequency of very fast moving objects the delays may be decreased and for measuring frequency of slow moving objects the delays may be increased.

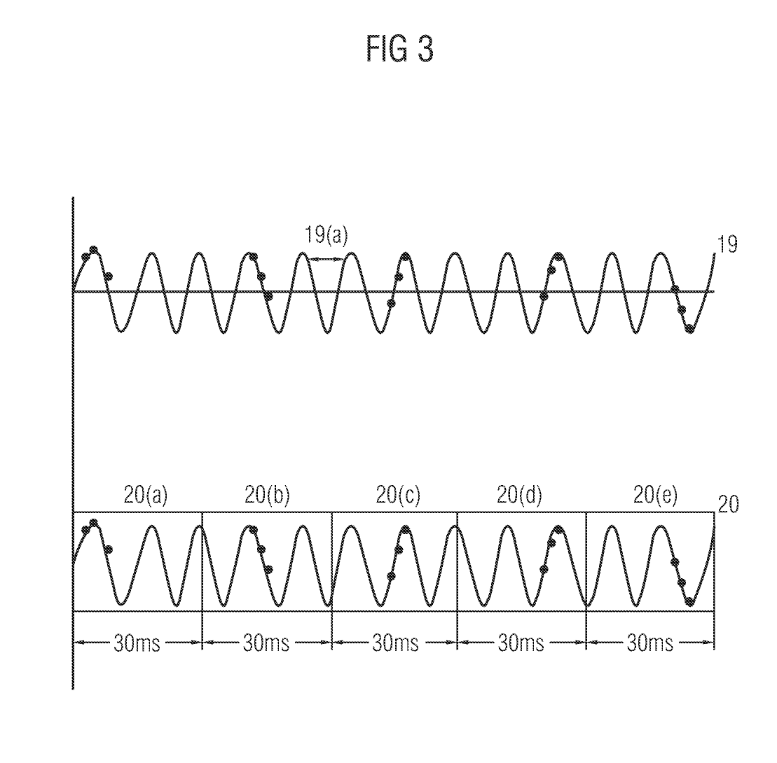

FIG. 3 illustrates an exemplary depiction of a sample collection phase of images according to an embodiment herein. As illustrated in FIG. 3, the signal 18 is the position of a point on an object 12 which is vibrating. The dominant cycle is selected, shown as 19(a) of which the frequency is to be measured. The apparatus 10 can collect three samples (20) every 30 ms apart and lighting allows collecting three samples at arbitrarily small intervals. Three samples depicted as dots are collected for every 30 ms cycle ((20(a), 20(b), 20(c), 20(d), 20(e)). Cycle 20(a) provides sample points (t1,y1), (t2,y2), (t3,y3), cycle 20(b) provides sample points (t4,y4), (t5,y5), (t6,y6), and the subsequent cycles so on. Here, (t1,y1) represents the time of acquisition of the sample and the position of a point on the object at the time of sample acquisition. The positions are located using feature points on the moving object 12 or using reflective markers. The sampling and analysis is performed based on a static vibration of the object 12. The samples collected are used to identify the dominant cycle of vibration. The vibration frequency can then be obtained by using the reciprocal of the time period of the cycle, which is performed using a time wrapping algorithm.

Here, one conventional image frame is split into three RGB frames, comprising of color planes acquired at small intervals apart. The sampling rates after three RGB frames are limited by a camera image acquisition interval, instanced as 30 ms. Since most systems vibrate periodically, it does not necessitate capturing many samples in one acquisition cycle itself. Samples at different positions in a 30 ms period are collected at different cycles. Thus adequate samples at different parts during one acquisition period of 30 ms are collected.

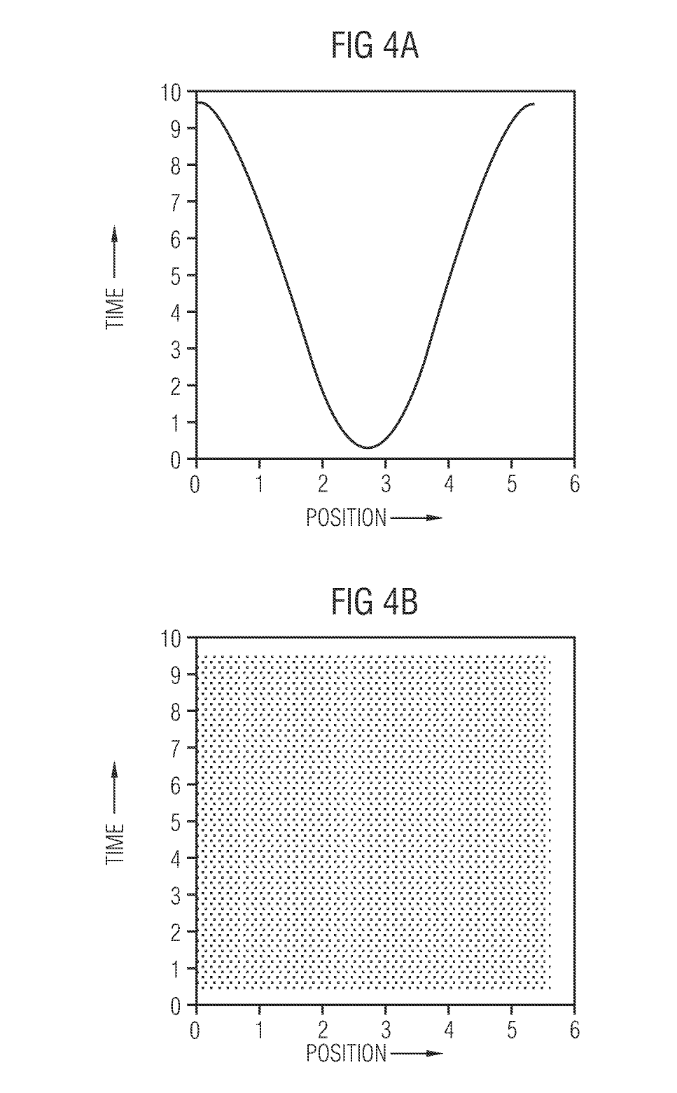

FIG. 4A illustrates an exemplary depiction of clustered image samples at correct wrapping time according to an embodiment herein. A time period Tw is initially set as an interval for image acquisition. The samples of image data at different positions are measured at different parts of the time period. The samples thus obtained are wrapped into the initialized time period Tw. For example, Tw=10, then the samples at (2.1, 3.2), (3.2, 0.123), (4.5, 0.34), (12.5, 0.91), (22.4, 0.21), (25.1, −2.3) would be wrapped as (2.1, 3.2), (3.2, 0.123), (4.5, 0.34), (12.5, 0.91), (22.4, 0.21), (25.1, −2.3). If the wrapping time of the samples matches with the initialized time period Tw, the sample image data points would be clustered as illustrated in FIG. 4A. This time period is then selected as the dominant cycle of the vibration phenomenon to further calculate the frequency of vibration.

FIG. 4B illustrates an exemplary depiction of scattered image samples at incorrect wrapping time according to an embodiment herein. A time period Tw is initially set as an interval for image acquisition. The samples of image data at different positions measured at different parts of the time period. The samples thus obtained are wrapped into the initialized time period Tw. If samples are wrapped at incorrect times as compared to initialized time period Tw, the sample image data points would be scattered as illustrated in FIG. 4B. In this case, error metric is obtained by measuring the root mean square value of the pair-wise distance between distinct consecutive points of the object 12. The time period Tw is then scanned and value of Tw corresponding to the least value of the error metric is calculated. This provides the dominant cycle of vibration of points 18 of the object 12. Frequency of vibration of the object 12 can thus be obtained by taking reciprocal of the time period of the dominant cycle.

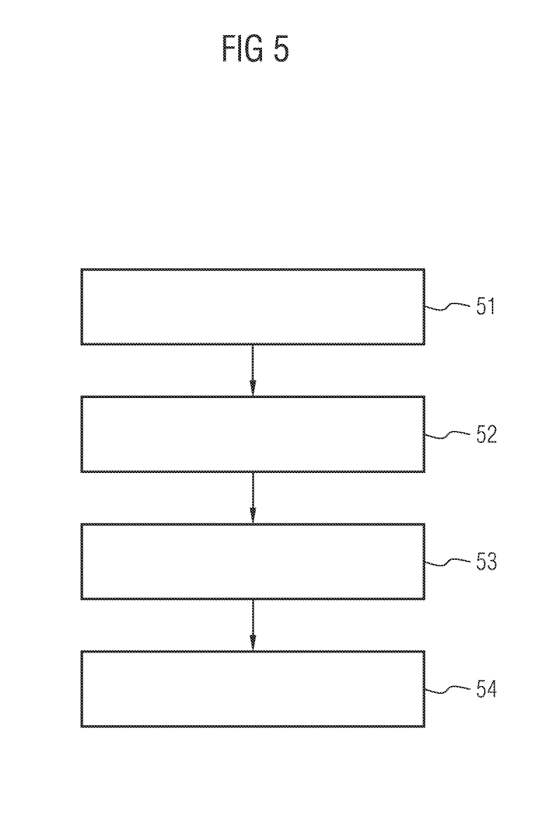

FIG. 5 illustrates a flow diagram illustrating a method of computing displacement at different points of the object according to an embodiment herein. At block 51, position information of the objects 12 is obtained in two color channels of the at least two color channels of the image. Next, at block 52, the objects 12 in the two color channels of the at least two color channels is reduced to a point 18 to obtain point sets. At block 53, the corresponding points 18 of the object 12 in the point sets of the two color channels of the at least two color channels of the image are mapped. Moving next to block 54, the displacement at various points 18 on the object 12 is computed as a distance between corresponding points 18 of the object 12 in two color channels of the image.

Preferably, the position information of the points 18 of the objects 12 in two color channels is obtained using a pattern matching algorithm.

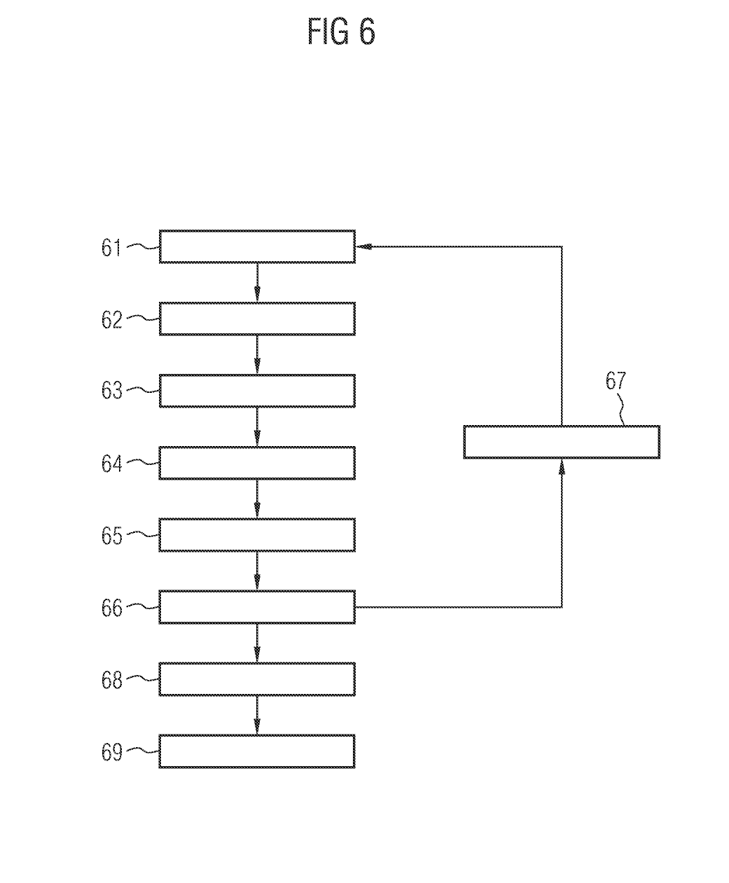

FIG. 6 illustrates a flow diagram illustrating a method of measuring frequency of vibration of an object using a time wrapping algorithm according to an embodiment herein. At block 61, the camera 13 is exposed towards the object 12 to capture the images of the vibrating object 12 in a single exposure frame. The illuminating device 11, which is an RGB strobing system acquires high speed images of the object 12 using RGB strobe light. At block 62, the object 12 is strobed with Red light and the red pixels acquire the image. A small interval of time later, the object 12 moves a few pixels away and the object 12 is then strobed with green light at block 63. At block 64, the object 12 is strobed with blue light. At block 65, the composite image results out as the camera 13 remains exposed for the entire time interval. At block 66, the strobe time of the object 12 and the feature points are captured and the positions and displacements of the points 18 on the object 12 are obtained. At block 67, the image acquisition cycle repeats after a small inter-cycle delay corresponding to image acquisition time. At block 68, the time wrapping algorithm is run on stored points 18. Next, at block 69, the frequency of vibrations is measured by computing the dominant cycle of image acquisition by mapping corresponding image data with a wrapping time of image data acquired.

Preferably, the image data points are clustered if wrapping time is same as that of initialized time period. If the wrapping time is different of the time period, a time period corresponding to least value of error metric of points 18 in point sets of the object 12 in the at least two color channels of the image is computed. Error metric represents root mean square value of the distance between distinct consecutive the points 18 in the point set of the object 12.

Thus, the embodiments described herein enable determining characteristics such as displacement, frequency, etc of an object moving at a high speed using a relatively less expensive camera. Moreover, accuracy of the parameters measured is relatively high. Additionally, the techniques described herein eliminate the requirement of high speed cameras, which are bulky and need external cooling systems, for capturing images of object 12 moving at a high speed. Further, the apparatus exhibits higher dynamic range and can be employed without additional fabrication.

In view of the foregoing, owing to the advantages described, the apparatus for measuring vibration frequency of an object disclosed herein has extensive applications in diverse fields. It can be used for prediction of loading and dynamic stresses and strains on mechanical parts such as crank shafts and shock absorbers for performance analysis. Generally, material life time is measured by the number of fatigue loading cycles which can be estimated by vibration frequency. The apparatus provides a better estimate of the life of a stressed object as the number of loading cycles is calculated in real time, thereby avoiding unpredicted damages.

The apparatus can be used for evaluating large civil structures, vibrating membranes and vibration mode shape analysis of objects.

While this invention has been described in detail with reference to certain preferred embodiments, it should be appreciated that the present invention is not limited to those precise embodiments. Rather, in view of the present disclosure which describes the current best mode for practicing the invention, many modifications and variations would present themselves, to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1.-24. (canceled)

25. A method of measuring vibration characteristics associated to an object, the method comprising:
illuminating the object using at least two light sources, the at least two light sources emitting light of distinct colors, wherein each of the at least two light sources are strobed at a respective delay;
capturing reflected light from the object to result into one image of the object, the image comprising at least two distinguishable color channels capable of distinguishing the distinct colors of the light; and
processing the image to compute the vibration characteristics associated with the object from positions of points on the object in the at least two distinguishable color channels of the image.

26. The method according to claim 25,
wherein each of the at least two light sources are strobed for a pre-determined on-time at the respective delay, and
wherein the respective delay is predetermined.

27. The method according to claim 25, wherein the at least two light sources are selected from the group consisting of a red light source, a green light source, and a blue light source.

28. The method according to claim 25, wherein a first vibrating characteristic associated with the object is selected from the group consisting of frequency and displacement.

29. The method according to claim 28, wherein the displacement is computed as a distance between positions of the points on the object in two color channels of the at least two distinguishable color channels of the image.

30. The method according to claim 29, wherein the displacement at the points on the object is located using feature points or reflective markers.

31. The method according to claim 28, wherein the displacement is computed using a pattern matching algorithm.

32. The method according to claim 31, wherein the computation of the displacement using the pattern matching algorithm includes:
obtaining position information of the points on the object in two color channels of the at least two color channels of the image,
reducing the object in the two color channels of the at least two color channels of the image to a point to obtain point sets,
mapping the corresponding points of the object in the point sets of the two color channels of the at least two color channels of the image, and
computing the displacement of the object as the distance between corresponding points of the object in the point sets of the two color channels of the at least two color channels of the image.

33. The method as claimed in claim 28, wherein the frequency of vibration of the object is computed using a time wrapping algorithm.

34. The method according to claim 33, wherein computation of the frequency using the wrapping algorithm includes:
initializing a first time period for obtaining position information of the point on the vibrating object in the at least two distinguishable color channels of the image,
wrapping position information of the points on the object in the two color channels of the at least two color channels of the image into the first time period,
mapping the corresponding the points of the object in the point sets of the two color charnels of the at least two color channels of the image at the time period, and
computing a second time period of a dominant cycle by equating wrap time period of the points with the first time period.

35. The method according to claim 34, wherein when the wrap time period is different than the first time period, a third time period corresponding to least value of error metric of the points in the point sets of the object in the at least two color channels of the image is computed.

36. The method according to claim 35, wherein the error metric represents root mean square value of the distance between distinct consecutive points in the point set of the object.

37. An apparatus for measuring vibration characteristics associated with an object, the apparatus comprising:
an illuminating device comprising at least two light sources, the at least two light sources emitting light of distinct colors, wherein each of the at least two light sources are strobed at a respective delay;
a color camera to capture reflected light from the object to result into one image of the object, the image comprising at least two distinguishable color channels capable of distinguishing the distinct colors of the light; and
a processing means to process the image to obtain the vibration characteristics associated the object from positions of points on the object in the at least two distinguishable color channels of the image.

38. The apparatus according to claim 37,
wherein each of the at least two light sources are strobed for a pre-determined on-time at the respective delay, and
wherein the respective delay is pre-determined.

39. The apparatus according to claim 37, wherein the at least two light sources are selected from the group consisting of a red light source, a green light source, and a blue light source.

40. The apparatus according to claim 37, wherein a vibrating characteristic associated with the object is selected from the group consisting of frequency and displacement.

41. The apparatus according to claim 40, wherein the displacement is computed as a distance between positions of the points on the object in two color channels of the at least two distinguishable color channels of the image.

42. The apparatus according to claim 41, wherein said displacement at the points on the object is located using feature points or reflective markers.

43. The apparatus according to claim 40, wherein the displacement is computed using a pattern matching algorithm.

44. The apparatus according to claim 43, wherein the computation of the displacement using the pattern matching algorithm includes configuring the processing means to:
obtain position information of the points on the object in two color channels of the at least two color channels of the image,
reduce the object in the two color channels of the at least two color channels of the image to a point to obtain point sets,
map the corresponding points of the object in the point sets of the two color channels of the at least two color channels of the image, and
compute the displacement of the object the as a distance between corresponding points of the object in the point sets of the two color channels of the at least two color channels of the image.
